(19) United States
(12) Patent Application Publication
(10) Pub. No.: US 2023/0245321 A1
(43) Pub. Date: Aug. 3, 2023

(54) COMPUTER VISION FOR REAL-TIME SEGMENTATION OF FLUORESCENT BIOLOGICAL IMAGES

(71) Applicant: Bio-Rad Laboratories, Inc., Hercules, CA (US)

(72) Inventors: Michael Joseph Griffin, Quincy, MA (US); Evan Paul Thrush, San Anseimo, CA (US)

(21) Appl. No.: 18/150,695

(22) Filed: Jan. 5, 2023

Related U.S. Application Data
(60) Provisional application No. 63/305,206, filed on Jan. 31, 2022.

(51) Int. Cl. G06T 7/194

(52) U.S. Cl. CPC G06T 7/194; G06T 2200/24; G06T 2207/10064

(57) ABSTRACT

A segmentation system processes images of a sample that includes fluorescent entities. The segmentation system applies a threshold image that represents background illumination distinct from fluorescence of target entities to pre-process the images. The segmentation system determines numbers of target entities in pre-processed images and determines whether an estimated number of target entities in the sample meets a threshold certainty. The segmentation system continues to analyze one or more images until the threshold certainty is determined. When the threshold certainty is met, the estimated number of target entities may be used to generate a user interface output (e.g., displaying the pre-processed images and visual indicators of the locations of target entities.

### CROSS-REFERENCE TO RELATED APPLICATION

This application claims benefit to U.S. Provisional Patent Application No. 63/305,206, filed on Jan. 31, 2022, which is incorporated by reference.

### TECHNICAL FIELD

The disclosure generally relates to automated entity detection in images and in particular, to the real-time segmentation of fluorescent target entities in assay images.

### BACKGROUND

Performing analysis of assay results (e.g., captured images) to identify a concentration of a target entity can demand a large amount of processing resources, memory resources, and time. Conventional systems acquire data for a long period of time before having accumulated enough data to make a determination on what type of entity is present and at what concentration level. Not only is all of this data stored, consuming a large amount of memory resources, but it is also processed, exhausting processing resources. This may severely limit or even prohibit the performance of assay analysis outside of a laboratory with access to significant computing resources. In turn, it is especially difficult for low resource environments, where target entity identification can be critical (e.g., for disease detection and control in remote or impoverished areas), to perform assays and analyze the results. Furthermore, the time needed for conventional systems to complete the analysis can be long (e.g., 20 minutes), compounded with a number of samples per source (e.g., each human patient's upper respiratory tract), can contribute to a bottleneck in scenarios where quick and prompt diagnosis and response (e.g., medical testing and care) is needed.

### SUMMARY

A segmentation system described herein performs a real time identification of target entities of a sample. The segmentation system may analyze images of a sample as they are captured to determine pixel(s) at which a target entity is likely to be located. To improve the accuracy of this real time determination, the segmentation system may first pre-process the images using threshold analysis. For example, a first set of the received images may be used to determine a threshold image, which can account for background light intensity (e.g., a flatfield image) or noise within the captured images. With each image analyzed, the segmentation system can determine if a threshold certainty level is reached. If the threshold certainty level is reached, the segmentation system can stop intaking and analyzing additional images. The segmentation may use the images already received to determine and output information (e.g., target entity type or concentration). In this way, the segmentation system reduces memory and processing resources that would otherwise be required by conventional systems that accumulates data (e.g., for a fixed amount of time or quantity of data) and processes all of the accumulated data to identify target entities. Furthermore, by stopping the analysis when a threshold certainty is reached rather than process a large amount of data, the segmentation system reduces the time needed to complete an assay, which can be critical in identifying a target entity (e.g., a viral protein) for controlling the spread of an illness or disease.

In one example embodiment, the segmentation system obtains images, as captured by an image sensor, of a sample that includes fluorescent entities. The image sensor may be a microscope that captures images of target antigens that bind to fluorophores in the sample. The segmentation system determines a threshold image to pre-process the images of the sample. The threshold image may represent background illumination differing from the fluorescence of the target entities. The threshold image can be determined using a first set of the images (e.g., the first five images received). The segmentation system pre-processes a second set of images (e.g., images received after the first set) using the threshold image, obtaining pre-processed images. The segmentation system determines a first number of target entities in a first image of the pre-processed images and a second number of target entities in a second image of the pre-processed images. Using the first and second numbers of target entities, the segmentation system may determine whether a first estimate of the number of target entities in the sample meets a threshold certainty. If the threshold certainty is not yet met, the segmentation system may continue to determine a third number of target entities in a third image of the pre-processed images. The segmentation system may determine whether a second estimate of the number of target entities, accounting for the third image, meets the threshold certainty. If the threshold certainty is met, the segmentation system may use the second estimate to generate a user interface output (e.g., displaying the pre-processed images and visual indicators of the locations of target entities according to the second estimate).

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 shows diagrams of binding in an assay, in accordance with at least one embodiment.

FIG. 2 depicts graphs and of binding signatures of entities in an assay, in accordance with one embodiment.

FIG. 3 shows a diagram of a binding signature obtained from images of an assay, in accordance with one embodiment.

FIG. 4 is a block diagram of a process for determining locations of target entities within an assay image, in accordance with one embodiment.

FIG. 5 is a block diagram of a process for pre-processing images for assay analysis, in accordance with one embodiment.

FIG. 6 is a block diagram of a system environment in which a segmentation system operates, in accordance with one embodiment.

FIG. 7 depicts colocation of two potential target entities, in accordance with one embodiment.

FIG. 8 shows a process for estimating and displaying a number of target entities in a sample, according to one embodiment.

FIG. 9 is a block diagram illustrating components of an example machine, in accordance with one embodiment.

### DETAILED DESCRIPTION

The Figures (FIGS.) and the following description describe certain embodiments by way of illustration only. One skilled in the art will readily recognize from the following description that alternative embodiments of the structures and methods may be employed without departing from the principles described. Wherever practicable, similar or like reference numerals identify similar or identical structural elements or identify similar or like functionality. For clarity within the figures, reference numerals may refer to less than all instantiations of the feature referenced.

### Entity Segmentation Overview

FIG. 1 shows diagrams of binding in an assay, in accordance with at least one embodiment. An assay may be used to identify the concentration of a target entity such as an antigen. To identify a concentration of target entities in a sample (e.g., a sample of fluid extracted from the human body), a segmentation system can analyze images of an assay to identify target entities binding to detection proteins (e.g., fluorophores) in the assay. The target entities generate fluorescing patterns as they bind to fluorophores. As shown in FIG. 1, target entities may bind to detection proteins (e.g., detection fabs) and capture proteins (e.g., capture antibodies). For example, a detection protein may be excited as it nears a biotin-PEG located at a surface of a coverslip. This detection protein may bind to a variety of entities within the assay solution, including a matrix component, biotin-PEG, or a target antigen. In nonspecific binding, as shown in the diagrams 100, 120, and 121, the detection protein binds to non-target entities such as a biotin-PEG or a matrix component. Binding can include nonspecific binding and repetitive binding. As the detection protein is excited, it emits light. In nonspecific binding, the detection protein can emit a single pulse of light, as shown in the graph 110, or pulses of light with relatively low frequencies, as shown in the graph 111. In repetitive binding, the detection protein has bonded to a target entity and emits pulses of light with a relatively greater frequency than nonspecific binding, as shown in the graph 112. The diagrams 102 and 122 show target entities binding to capturing proteins and detection proteins that produces the higher frequency twinkling shown in the graph 112. The graphs 110, 111, and 112 depict fluorescence arbitrary units (AU) over time (t).

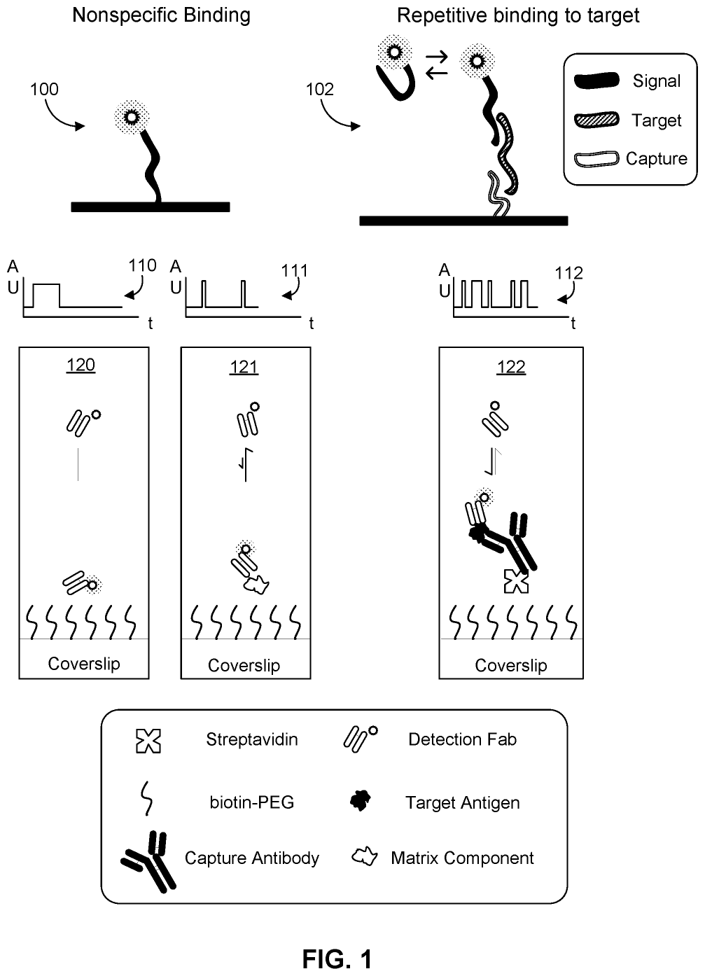

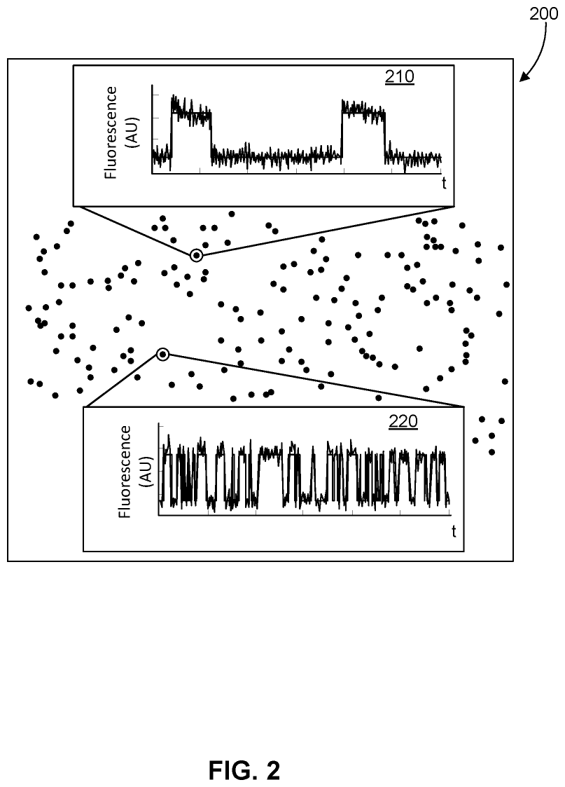

FIG. 2 depicts graphs 210 and 220 of binding signatures of entities in an assay 200, in accordance with one embodiment. A binding signature can be modeled as or represented by a binary pattern of ON or OFF states over time, where an ON state corresponds to a high fluorescing intensity (e.g., meeting or exceeding a fluorescing threshold) and OFF state corresponds to a low fluorescing intensity (e.g., below the fluorescing threshold). The pulses of light emitted by a fluorophore that is bonded to an entity can be captured by an image sensor. For example, an assay of a sample of an unknown concentration of a target entity may be subjected to the lens of a microscope (e.g., an electron microscope). The images of the sample can be transmitted to the segmentation system described herein to identify the concentration of the target entity in the sample. An image of the assay 200 may depict spots corresponding to the light-emitting fluorophores that have bonded to an entity (e.g., nonspecific or repetitive binding). The blinking patterns of light, which are referred to as “binding signatures,” are used to determine whether the fluorophore has bonded to a target entity. In the graph 210, the binding signature of the entity bonded to a fluorophore has a lower frequency than is characteristic of the frequency of a binding signature of a target entity bonded to a fluorophore, which is depicted in the graph 220.

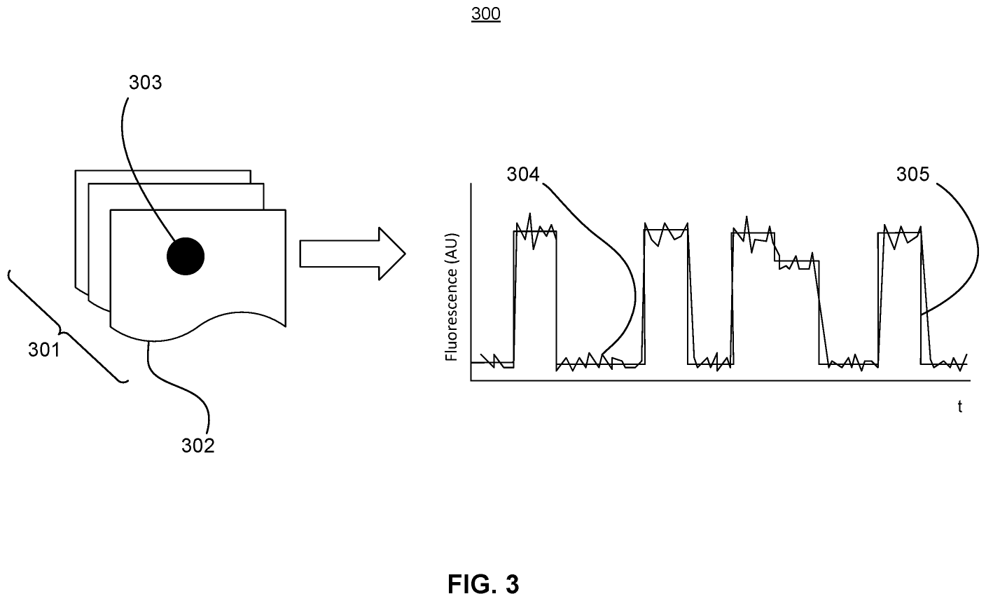

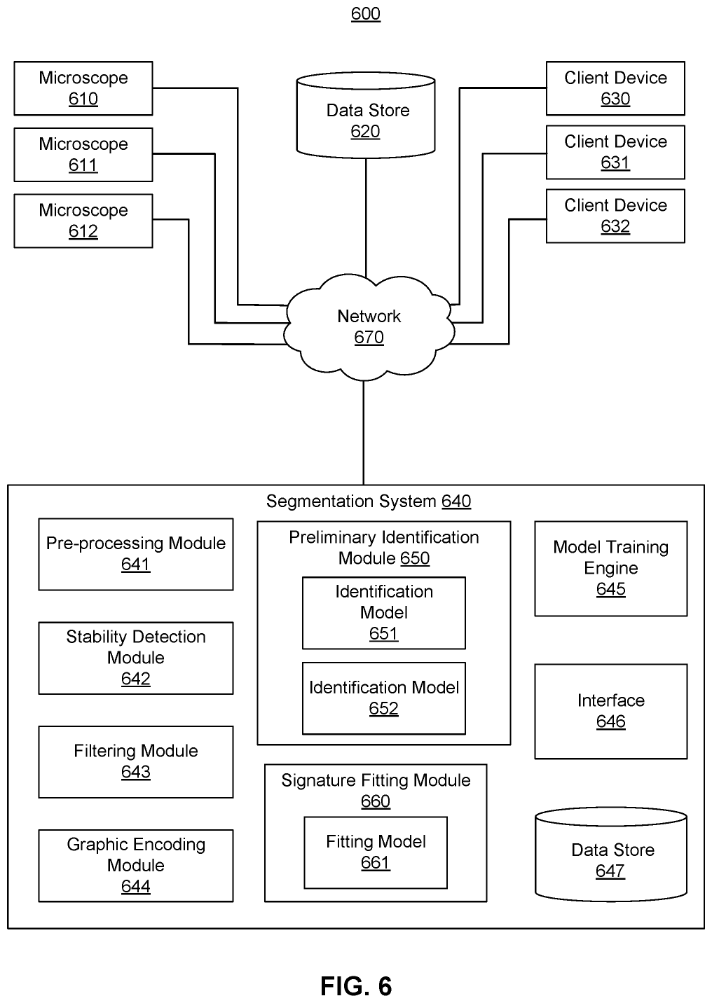

FIG. 3 shows a diagram 300 of a binding signature 305 obtained from images 301 of an assay, in accordance with one embodiment. The images 301 include an image frame 302 that depicts an image location 303 where the intensity varies across the images 301. An image location may also be referred to as an “image pixel.” An intensity of an image pixel may be referred to as an “image value.” The segmentation system can identify target entities that have bonded to fluorophores in one image or consecutively captured images at an image location or a region of image locations. The segmentation system can use the image value in a single image or across consecutively captured image. Identification of target entities is described in further detail in the description of FIG. 6. After identifying the location of a target entity in an image, the segmentation system can identify the intensity at that image location over time, creating the trace 304 of the target entity. The segmentation system can derive the binding signature 305 by fitting the trace 304 into binary values. These binary values represent the ON and OFF states of the fluorescence.

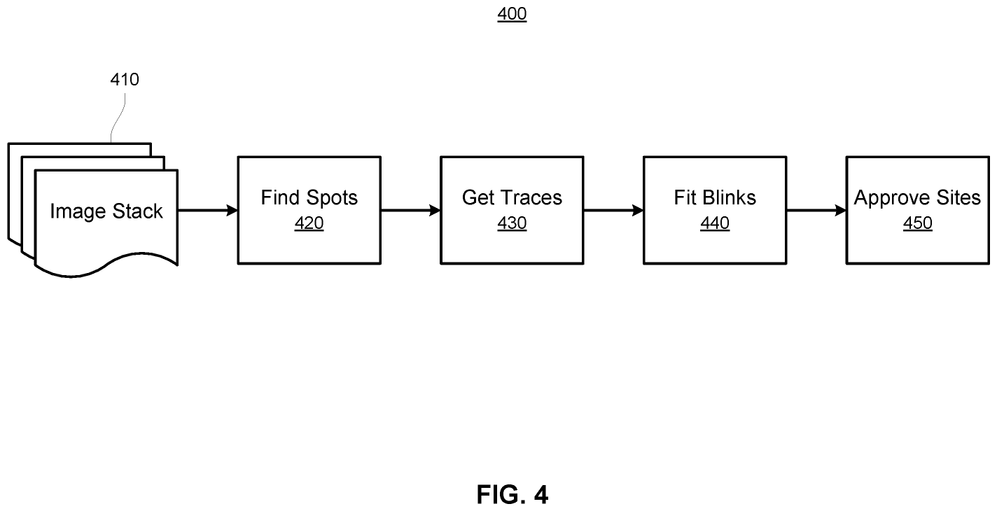

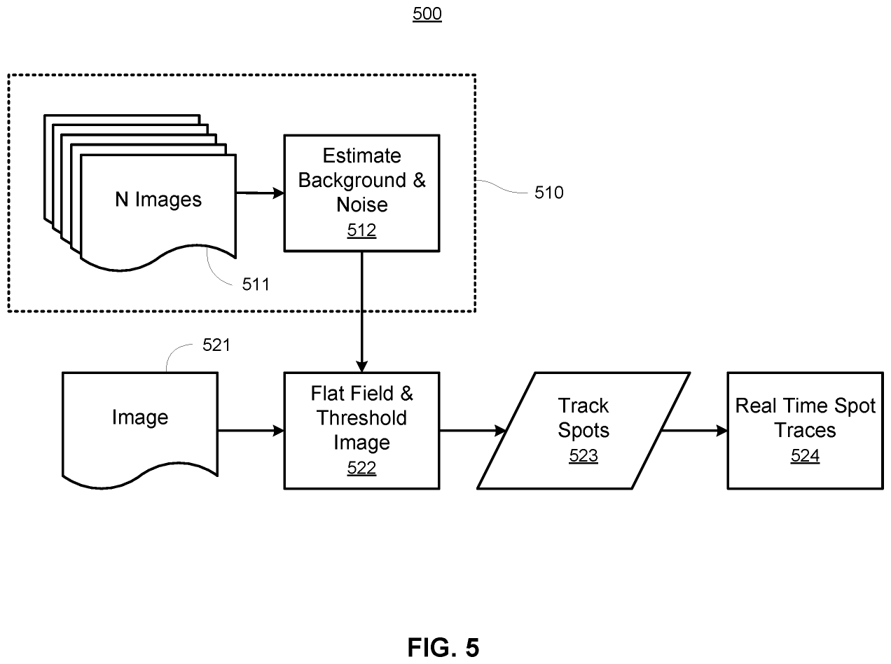

FIG. 4 is a block diagram of a process 400 for determining locations of target entities within an assay, in accordance with one embodiment. There may be different, additional, or fewer operations in the process 400 for determining target entities. For example, a pre-processing operation may be performed to reduce background noise of the images (e.g., as shown in FIG. 5). The process 400 can be performed by the segmentation system. The segmentation system receives the images 410 and finds 420 spots in the images 410 at which a target entity is likely to be located. The spots may be an image location or a region of image locations. Spots may be location(s) where the variation in intensity across images or the amount of intensity in one or more images qualifies to be considered a location of a target entity. The segmentation system may determine these spots by applying a set of rules (e.g., a rule-based model) or a machine learning model to one or more of the images 410. After identifying the locations, the segmentation system determines 430 traces of the intensity values over time of the identified spots. For example, the segmentation system may determine traces of intensity values of an image location over consecutive images or the average intensity values of a region of image locations over consecutive images.

The segmentation system fits 440 binary patterns, referred to as “blinks,” to the traces. For example, the segmentation system fits the traces by binarizing the intensity values for the spots. After fitting blinks to the traces, the segmentation system approves 450 the sites of target entities in the images of a sample. In some embodiments, the segmentation system can filter out one or more of the identified spots as false positives. Filters can include determining a single target entity has been overcounted across multiple spots or determining that a nonspecific binding signature of a non-target entity was mistakenly identified as the binding signature of a target entity. The remaining spots may be approved sites at which a target entity is located (e.g., a target entity per approved site). Additional details of the operations described with respect to the block diagram 400 are provided in the description of the segmentation system in FIG. 6.

FIG. 5 is a block diagram of a process 500 for pre-processing images for assay, in accordance with one embodiment. The process 500 can be performed by the segmentation system. One or more images (e.g., image 521) may be pre-processed using a flat field and threshold image 522, or “threshold image.” To determine the threshold image 522, the segmentation system performs sub-process 510, where the segmentation system estimates 512 background intensity and background noise of a set of images 511. The set of images 511 may be a subset of images captured during a single assay that also includes the frame 521 that is being pre-processed. In some embodiments, the set of images 511 is captured separately from the assay for which the image 521 is captured, but the set shares characteristics with the image 521. One example characteristic is the same image sensor (e.g., microscope) or type of image sensor capturing the set of images 511 and the image 521. Shared characteristics may generally relate to the manner by which the images are captured (e.g., hardware, environment, etc.) or the content depicted within the images (e.g., types of entities within the assay). The segmentation system may estimate 512 background intensity and background noise in the set of images 511 by partitioning each image into a grid of sub-images. The segmentation system determines the background intensity and background noise for each sub-image of the set of images 511. In one example, the segmentation system uses a histogram to determine a background intensity and determines standard deviation to determine background noise. The segmentation system re-assembles the background intensities and noises of the sub-images into matrices of background intensities and noises. The threshold image 522 is a combination of a background intensity matrix and a background noise matrix. The determination of a threshold image is further described in the description of FIG. 6 with respect to the pre-processing module 641.

The segmentation system 522 applies the threshold image 522 to the image 521 by comparing image values of the image 521 to the threshold image 522 (e.g., a pixel by pixel comparison). In one example, the segmentation system may binarize the image 521 using the threshold image 522. In another example, the segmentation system may filter out values that are below the corresponding threshold image pixels' values and keep the values that meet or exceed the corresponding threshold image pixels' values. After applying the threshold image 522 to the image 521, the segmentation system tracks 523 spots within the pre-processed image. The segmentation system may identify spots within the image using a model (e.g., rule-based or machine learning). Tracking spots by determining likely locations of target entities is described further in the description of the preliminary identification module 650 of FIG. 6. As the segmentation system tracks 523 spots, the system may output traces 524 in substantially real time. For example, for each image pre-processed by the threshold image 522, the segmentation system may use previously tracked spots or determine additional spots to track and determine the image value at the tracked spots. The determined image value may be a value added to the traces 524 of the spots. As the images received for pre-processing and spot tracking are received in substantially real time (e.g., as they are captured by an image sensor), the traces can also be output in substantially real time.

### Segmentation System Architecture

FIG. 6 is a block diagram of a system environment 600 in which a segmentation system 640 operates, in accordance with one embodiment. The system environment 600 includes microscopes 610-612, a data store 620, client devices 630-632, the segmentation system 640, and a network 670. The system environment 600 may have alternative configurations than shown in FIG. 6, including different, fewer, or additional components. For example, the system environment 600 can include fewer microscopes or client devices than depicted.

The segmentation system may analyze images of a sample as they are captured (e.g., by a microscope) to determine image locations at which a target entity is likely to be located substantially in real time. As used herein, “real time” means within a fraction of the time for an image frame to be captured (e.g., before the next image frame is acquired). For example, for a frame rate of 2 frames per second (i.e., 0.5 seconds between frames), the system may analyze each image within 0.5 seconds after receiving the image. The system may additionally analyze images within ±10% of a time period between frames (e.g., within 0.45-0.55 seconds for a frame rate of 2 frames per second). By analyzing an image frame in substantially real time, before the next image frame is acquired, the segmentation system may avoid accumulating a backlog as images are received for processing. To improve the accuracy of this real time determination, the segmentation system may first pre-process the images using threshold analysis. For example, a first set of the received images may be used to determine a flatfield and threshold image, which can account for background light intensity or noise within the captured images. With each image analyzed, the segmentation system can determine if a threshold certainty level is reached. If the threshold certainty level is reached, the segmentation system can stop analyzing additional images and output information (e.g., target entity type or concentration) determined from the images that have already been analyzed.

The microscopes 610-612 may be different types of microscopes suitable for assay (e.g., assay of proteins) or microscopes associated with various organizations (e.g., academic institutions, medical care providers, pharmaceutical corporations, etc.) The data store 620 stores data determining target entities in a sample. This data can include reference data such as previously measured binding signatures of entities, which can be stored in a mapping to the dilution series concentrations of the assays in which they were measured. The data may include image data captured by the microscopes 610-612, where the images depict assays. The image data may be used to train models used by the segmentation system 640 in identifying target entity locations in images (e.g., by the model training engine 645). The image data may be used for assaying a protein concentration (e.g., using previously collected data in place of a real time determination of target entity locations and traces). The data can include a color code mapping colors to rules or tests that image locations passed or failed. As discussed with regard to the graphic encoding module 644, this color code can be used to encode pre-processed images into color-coded versions. The color-coded versions can be displayed (e.g., at a client device) as they are processed, providing a user with a substantially real time, color-coded feed of the processing performed by the segmentation system 640 in determining target entity locations. The data stored in the data store 620 may be similarly or the same as the data stored in the data store 647. In one example, the data store 647 may be used to perform target entity identification when the segmentation system 640 is offline from the network 670.

The client devices 630-632 are examples computing devices for users to send requests to and receive segmentation results from the segmentation system 640. For example, system 640 may provide for display on the client device 630 an interface to begin performing an assay analysis, specify an image sensor from which to receive images for target entity identification, view a real time determination of binding signatures of target entities in the images, or view a color-coded stream of the processed images. In some embodiments, the computing devices are conventional computer systems, such as a desktop or a laptop computer. Alternatively, the computing device may be a device having computer functionality, such as a smartphone, tablet, or another suitable device. The computing device is configured to communicate with system 640 via network 670, for example using a native application executed by the computing device and that provides functionality of system 640, or through an application programming interface (API) running on a native operating system of the computing device, such as IOS® or ANDROID™ Some or all of the components of a computing device are illustrated in FIG. 11.

The segmentation system 640 includes software modules such as a pre-processing module 641, a stability detection module 642, a filtering module 643, a graphic encoding module 644, a model training engine 645, a preliminary identification module 650, and a signature fitting module 660. The segmentation system 640 includes a data store 647 that may store similar data as stored in the datastore 620. The segmentation system 640 includes an interface 646 to enable communication between the segmentation system 640 and external entities (e.g., the client devices 630-632). The segmentation system 640 may have alternative configurations than shown, including different, fewer, or additional components. In another example, the model training engine 645 is not included in the segmentation system 640 and models applied by the segmentation system 640 may be trained remote to the segmentation system 640.

The pre-processing module 641 pre-processs a set of images for processing by the segmentation system 640. The set of images can be captured in a similar manner. For example, a set of images can be captured during the same session of using the microscope 610, and the pre-processing module 641 pre-processs that set of images for processing by the preliminary identification module 650. The pre-processing module 641, to pre-process the images, can determine a threshold image using a subset of images received (e.g., from a microscope, a client device, or a data store). In some embodiments, the pre-processing module 641 determines a background image, determines a standard deviation image using the background image, and determines the threshold image using the background and standard deviation images. The pre-processing may be performed once (e.g., per collected sample) or periodically (e.g., every 100 images received). The pre-processing may be performed upon user request.

The pre-processing module 641 may determine the background image by using a histogram and a first set of images received. The first set of images received may be a first number of images received from a feed of images. In one example, the first number of images is the first five consecutive images received. The pre-processing module 641 may partition each image in the first set of images using a grid of sub-images. For example, each of the first set of images can be partitioned using a grid of twelve to thirty-two sub-images. The pre-processing module 641 may determine a background intensity and a background noise of each sub-image by determining a histogram of intensities of image values within each sub-image. The pre-processing module 641 determines a histogram of intensities for a sub-image by identifying the number of occurrences of image values within the same sub-image across each of the first set of images. For example, the first sub-image is at the top left of the grid of sub-images and the pre-processing module 641 determines the histogram of intensity values of the top left sub-image for each of the first set of images.

In one embodiment, the pre-processing module 641 identifies the lowest prominent peak of a histogram of intensities and records the height and width of this peak. The lowest prominent peak refers to a peak of the histogram at a relatively low intensity with a count above a particular threshold to be considered a relatively prominent peak. The pre-processing module 641 may identify peaks by comparing counts in consecutive bins and determining a bin whose count is greater than counts of adjacent bins. The peak of the histogram can be the local background illumination intensity (background intensity) of a sub-image. The standard deviation of intensities within the width of the peak may represent the amount of background noise of the sub-image. The pre-processing module 641 may assemble the background intensities for each of the sub-images to determine a background image. For example, the pre-processing module 641 determines a matrix of background intensities corresponding to the grid of sub-images. The background image can be represented by this matrix. The pre-processing module 641 may assemble the background noises for each of the sub-images to determine a standard deviation image for the first set of images. The standard deviation image may similarly be represented by a matrix of background noises.

The pre-processing module 641 may determine the threshold image of the first set of images by using the background image and the standard deviation image. In some embodiments, the pre-processing module 641 uses an algorithm combining the background and standard deviation images and multipliers to determine the threshold image. In an example algorithm, the pre-processing module 641 calculates the threshold image by adding the background image to the standard deviation image multiplied by a variable factor (e.g., four).

The number of images used by the pre-processing module 641 to determine the threshold image may vary. In some embodiments, the segmentation system 640 may automatically adjust the number of images used to determine a threshold image. For example, in response to the stability detection module determining that a number of target entities in a sample is not above a threshold certainty for a consecutive number of attempts to exceed the threshold certainty, the pre-processing module 641 may increase the number of images used to determine a threshold image. In another example, the pre-processing module 641 may decrease the number of images in response to determining that the number of target entities in the sample is above the threshold certainty (e.g., above 10% of the threshold for a consecutive number of determinations). The decrease in images used by the pre-processing module 641 may be advantageous in conserving processing resources. The increase in images used by the pre-processing module 641 may be advantageous in improving the accuracy of the segmentation system 640.

The pre-processing module 641 may use the threshold image to pre-process images of a sample. In some embodiments, two sets of images of a sample are used to determine the threshold image and the pre-processed images, respectively. The pre-processing module 641 compares each unpre-processed image to the threshold image. The pre-processing module 641 determines if a given image pixel location's intensity value is above or below the value of the corresponding image pixel location at the threshold image. The pre-processing module 641 may store the comparison in a binary image or binary mask. When the intensity value is above the value of the corresponding image location at the threshold image, the pre-processing module 641 sets the binary mask image value to 1. When the intensity value is below, the pre-processing module 641 sets the binary mask image value to 0. Each binary mask may be a pre-processed image that is used to determine an estimated number of target entities within a sample. The preliminary identification module 650 may access the pre-processed images to make this determination. The signature fitting module 660 may use the pre-processed images and the estimated number of target entities to determine blinking signatures of the fluorescing target entities.

The stability detection module 642 determines whether an estimate of a number of target entities in a sample is stable (e.g., to be sufficiently certain of the number of target entities in the sample). The estimated number of target entities may be determined by the preliminary identification module 650. In some embodiments, the stability detection module 642 determines a certainty of the estimated number of target entities and compares the determined certainty against a threshold certainty. In one example of determining a certainty, the stability detection module 642 may compare a number of estimated target entities over time (e.g., determining a difference between a first and second estimated number of target entities). The comparison may represent the certainty of the estimated number of target entities. The stability detection module 642 may determine that the differences among the estimated numbers have remained within a threshold range. For example, the difference in estimated number of target entities between frames does not vary above or below 5% of the estimated number of target entities in the frames. Similarly, this threshold range may be manually configured. If this difference remains within the threshold range (e.g., for a preconfigured number of image frames), the stability detection module 642 may determine that the estimated number of target entities in a sample meets a threshold certainty. In another example of determining a certainty, the preliminary identification module 650 may use a machine-learned model that outputs a confidence score, and the stability detection module 642 may consider the confidence score as a certainty of the estimated number of target entities. If the determined certainty of the estimated number of target entities meets or exceeds the threshold certainty, the stability detection module 642 may cause the interface 646 to generate the estimated number of target entities for display at a client device. If the determined certainty does not meet the threshold certainty, the stability detection module 642 may cause the preliminary identification module 650 to determine another estimate of the number of target entities in a sample until the stability detection module 642 determines that the threshold certainty is met. The threshold certainty may be manually configured by receiving the threshold from a client device of a user (e.g., via a GUI generated by the interface 646).

The filtering module 643 determines target entities identified by the preliminary identification module 650 that were identified in error. Sources of erroneous identification may include overcounting a single target entity across multiple image locations (e.g., adjacent image locations) or movement of an unbonded entity having an amount of brightness, despite not binding to a fluorophore, that is captured by an image sensor. The filtering module 643 may be used after the preliminary identification module 650 determines image locations of target entities and before the signature fitting module 660 determines binding signatures of the target entities.

The filtering module 643 may identify a single target entity that is depicted over more than one image location and preserve a single image location as the actual location of the target entity. The multiple image locations at which the single target entity is depicted may be collectively referred to as a “colocation region.” The filtering module 643 may access the locations of target entities as determined by the preliminary identification module 650. The locations may be a single image location (e.g., a single image pixel) or a region of image locations (e.g., a bounding box in which the identification model 651 predicts with high confidence that a target entity is located). The filtering module 643 may determine that two or more target entity locations represent a colocation region because the two or more target entity locations are within a threshold distance of each other. This threshold distance may be manually configured. The filtering module 643 may determine that two or more regions of image locations overlap such that only one target entity is likely to be located in the overlapping regions. For example, the filtering module 643 may determine the center of bounding boxes are the same or within a threshold distance of each other. In response, the filtering module 643 may determine that there is a single target entity associated with the bounding boxes rather than multiple, distinct target entities.

The filtering module 643 can identify unbonded entities based on their motion. The brightness of the unbonded entities and their motion can create rings of light that is captured by an image sensor. The filtering module 643 identifies the rings of light across consecutive images that are at an ON state for longer than a threshold time period. For example, the filtering module 643 may identify a set of image locations for which corresponding image values exceed a threshold value, or a “fluorescing threshold,” for over a threshold number of consecutive images frames. An image value exceeding the fluorescing threshold may be considered as having an ON state. A ring of light may be represented in an image as a region of image values at an ON state with one or more sub-regions within the region having image values at an OFF state. The region or area within the ring of light, which may be inclusive of the ring itself, may be referred to as an “exclusion zone.” The size of the region may be limited based on a manually configured limit (e.g., maximum height and width of a region set by a user). After identifying rings of light, the filtering module 643 may determine that target entities having image locations within the ring are not actually target entities and remove the false positives from being processed by the signature fitting module 660.

The graphic encoding module 644 determines a color-coded version of an image of a sample. The graphic encoding module 644 may access determinations (e.g., for each image location in an image) of whether a target entities are present at image locations. The determinations may be made by the preliminary identification module 650 using models such as a rule-based identification model 652. The determinations can include the results of tests applied by the rule-based identification model 652. The test results may be mapped to corresponding colors. This mapping may be stored at the data store 620 or 647. In one example, a first color is used to denote that the image location passed all tests of the rule-based identification model 652, a second color is used to denote that the image location failed all tests of the rule-based identification model 652, a third color is used to denote that the image location exclusively passed a test for a minimum ON duration, etc. Various colors can be used to denote the passing or failing of tests for identifying whether a target entity is located at a given image location. The graphic encoding module 644 determines a color with which an image location should be encoded and thus, can determine a color-coded version of an image of a sample.

The graphic encoding module 644 may determine color-coded versions of images as they are received and processed by the preliminary identification module 650 such that a substantially real time feed of the determinations by the preliminary identification module 650 can be displayed (e.g., via the interface 646). In one example, the pre-processing module 641 pre-processs received images of samples in substantially real time as they are captured by an image sensor, the preliminary identification module 650 determines, using the pre-processed images, whether target entities are present at each image location of the images (e.g., determining which test(s) the image locations pass or fail), the graphic encoding module 644 determines colors for the determinations at each of the image locations, and color-coded images of the sample are presented to the client device 630 for display via the interface 646.

The model training engine 645 trains a machine learning model to identify image locations or regions of image locations of target entities within a sample. The model training engine 645 may access historically captured images of assays (e.g., from the data store 620). The images may be manually labeled with the locations or numbers of target entities within each image, or the model training engine 645 may use computer vision to automatically label the historically captured images. In one embodiment, the model training engine 645 generates a first training set using the labeled, historically captured images and trains a machine learning model with the first training set. The model training engine 645 may receive user feedback indicating an approval or disapproval of a determination of target entity image locations by the machine learning model. The model training engine 645 may generate a second training set using the user feedback and re-train the machine learning model using the second training set. The model training engine 645 may determine a cost function associated with the model and re-train the machine learning model to minimize the cost function. The model training engine 645 may additionally or alternatively train a machine learning model for fitting a determined binding signature to a known binding signature. For example, the model training engine 645 may generate a training set of historically determined binding signatures labeled with a target entity or target entity concentration in the assay. The model training engine 645 may train a machine learning model to classify a binding signature as belonging to a particular target entity or target entity concentration using the training set.

The interface 646 is an interface for a user to interact with the segmentation system 640. The interface 646 may be a web application that is run by a web browser at a client device or a software as a service platform that is accessible by the client device through the network 670. The interface 646 may be the front-end component of a mobile application or a desktop application. In one embodiment, the interface 646 may use application program interfaces (APIs) to communicate with client devices, which may include mechanisms such as webhooks.

The interface 646 can include a graphical user interface which includes graphical elements and control elements that a user may interact with to communicate with the segmentation system 640. In one example, the interface 646 includes a GUI for sending requests to initiate analysis of an assay. In another example, the interface 646 includes a display of the images received by an image sensor, images as pre-processed by the pre-processing module 641, target entities locations as determined by the preliminary identification module 650, binding signatures as determined by the signature fitting module 660, images with target entities filtered out by the filtering module 643, a color coded version of the pre-processed or filtered images as determined by the graphic encoding module 644, or a combination thereof.

The preliminary identification module 650 determines a number of target entities in a sample. The preliminary identification module 650 may access pre-processed images, as output by the pre-processing module 641, to determine the number of target entities in a sample. A target entity fluoresces to produce a blinking, ON/OFF signal. The presence of this signal, or blink, is detected by the preliminary identification module 650 to determine that a target entity is located at the image location at which the blinking is occurring across images. In various embodiments, the preliminary identification module 650 includes one or more models for identifying the presence of a target entity in an image. The preliminary identification module 650 is depicted as including two identification models 651 and 652, which can correspond to a machine learning model and a rule-based model. The preliminary identification module 650 may include more or less models for determining the presence of a target entity than depicted in FIG. 6.

The identification model 651 can be a machine learning model. The machine learning model can be trained, using historical images of target entities labeled with an indication of the presence of the target entities (e.g., labeled using the number of target entities), to determine a number of target identities within a given image. The machine learning model can be trained using a labeled set of images of a sample such that the model is configured to determine a number of entities depicted across multiple images. The identification model 651 may output a bounding box centered around each image location having a likelihood of being a target entity above a particular threshold. This threshold may be a threshold certainty that is used by the stability detection module 642. In some embodiments, the input to the identification model 651 is image data including image locations and the corresponding values. The input to the identification model 651 may also include contextual information regarding the received images such as information regarding the image sensor used to capture the images (e.g., microscope specification data), one or more entities known to be present in the sample, or any suitable information describing the images, the capturing of the images, or the contents depicted in the images. The output of the identification model 651 may include a number of target entities identified, the image locations of the identified target entities, or both. The model training engine 645 may train the identification model 651 and re-train the identification model 651 using feedback from a user. The training and re-training is discussed in further detail with respect to the description of the model training engine 645.

The identification model 652 can be a rule-based model. The rule-based model can include one or more tests or conditions that when satisfied indicate the presence of at least one target entity. An example test may compare an image value to a threshold value to determine that the image location corresponding to the image value is likely the location of a target entity. If multiple images are being applied to the identification model 652, the identification model 652 may apply yet another test to identify traversals of an off-to-on and on-to-off states once the image location is flagged as a likely location. For example, the identification model 652 may determine the image values at the likely location across consecutively captured images to determine whether the values pass a test for state transitions from off-to-on and on-to-off. The identification model 652 may use manually configured ranges of image values for ON and OFF states. If the values across consecutively captured images makes the transitions, then the identification model 652 may determine that the image locations of those values are where target entities are located. Other examples of rules to determine image locations having target entities can include an average time of a state is either ON or OFF, the number of transitions, the duration of the longest time a state is either ON or OFF, the intensity of an image value being at an ON state, the frequency of ON or OFF, or any suitable parameter describing the state of an image value. The output of the identification model 652 may include a number of target entities identified, the image locations of the identified target entities, or both.

The preliminary identification module 650 may use a single image or multiple images to determine a number of target entities in a sample. For example, the preliminary identification module 650 may apply the identification model 651 (a machine learning model) to one image or a set of images (e.g., consecutively captured images) of a sample. In another example, the preliminary identification module 650 may apply the identification model 652 (a rule-based model) to one image or a set of images of a sample. The output of either model can be a number of target entities depicted in the sample.

The signature fitting module 660 determines binding signatures of target entities and fits the determined binding signatures to signatures of known entities. The signature fitting module 660 includes a fitting model 661 that can determine a known entity whose signature has the most probable fit with the determined binding signature. A binding signature may be a pattern of image values of an image location over time as represented by consecutively captured images. The binding signature may be a binary pattern. Binding signatures of known entities may be referred to as “predetermined binary patterns,” where each predetermined binary pattern can belong to a different known entity. The signature fitting module 660 receives the locations of likely target entities from the preliminary identification module 650. The signature fitting module 660 may use the image values of the likely target entities to determine the corresponding binding signatures. The signature fitting module 660 may access the binding signatures of known entities from the data store 620 or 647.

The fitting model 661 is a model that fits a determined binding signature to a known entity's binding signature. The fitting model 661 may be a machine learning model trained by the model training engine 645. The signature fitting module 660 may generate a feature vector of data related to a binding signature such as the frequency of an ON or OFF state, the longest duration of an ON or OFF state, the minimum duration of an ON or OFF state, etc. The fitting model 661 may be a statistical model generated using historical images of samples, known dilution series used in the samples, known concentrations of entities depicted in the samples, or a combination thereof. The fitting model 661 may determine a correlation between the binding signatures depicted in the historical images and the known dilution series or known concentrations of entities. In this way, the segmentation system 640 may use the fitting model 661 to determine a correlation between a determined binding signature and a known entity's binding signature. In particular, the fitting model 661 may serve as a reverse-lookup for concentration of an entity given a measurement made by an instrument (e.g., images captured by a microscope).

The network 670 may serve to communicatively couple the microscopes 610-612, the data store 620, the client devices 630-632, and the segmentation system 640. In some embodiments, the network 670 includes any combination of local area and/or wide area networks, using wired and/or wireless communication systems. The network 670 may use standard communications technologies and/or protocols. For example, the network 670 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 670 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 670 may be encrypted using any suitable technique or techniques.

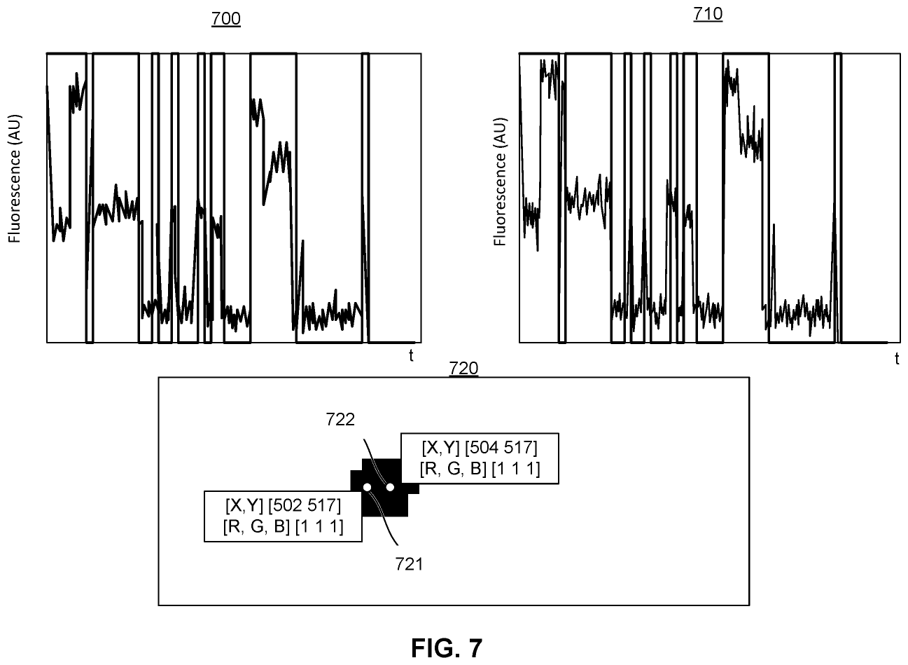

FIG. 7 depicts colocation of two potential target entities 721 and 722, in accordance with one embodiment. After the segmentation system identifies image locations of target entities, the segmentation system may filter target entities that are collocated with one another as being a single target entity rather than multiple. In determining that the target entities 721 and 722 are collocated, the segmentation system may determine that target entities 721 and 722 satisfy a set of rules for colocation. The rules may include that the two target entities have substantially similar binding signatures, as shown in the graphs 700 and 710 of the binding signatures of the entities 721 and 722 respectively. The rules may further include that the two target entities are within a threshold distance of one another. For example, the entities may be within five pixels of each other horizontally and vertically to satisfy this rule.

### Example Entity Segmentation Process

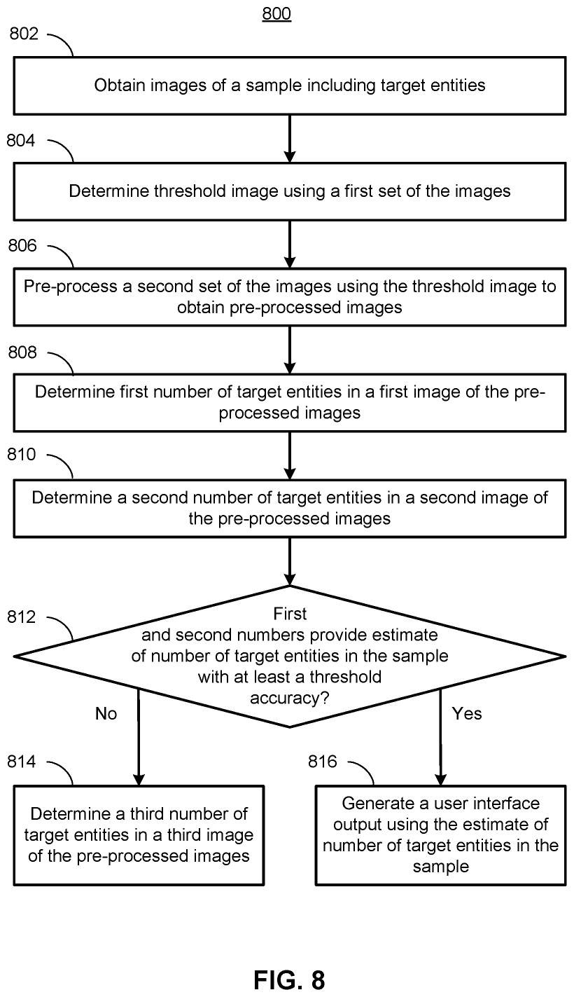

FIG. 8 shows a process 800 for estimating and displaying a number of target entities in a sample, according to one embodiment. The process 800 may be performed by the segmentation system. There may be additional, fewer, or different operations within the process 800. For example, after determining 814 a third number of target entities, the process 800 may return to determining 812 whether, using the third number of target entities, the estimated number of target entities in the sample has reached at least a threshold certainty. The operations within process 800 may also be performed in a different order than shown.

The segmentation system obtains 802 images of a sample including target entities. The images may be captured by an image sensor such as a microscope. The sample may include fluorescent entities such as target entities (e.g., target antigens) bonded to detection proteins (e.g., fluorophores). The segmentation system may pre-process the obtained images before determining the locations of target entities within the images. The segmentation system determines 804 a threshold image using a first set of the images. The segmentation system may use five consecutively captured images to determine the threshold image (e.g., by determining the background noise and background intensities of sub-images of the five images).

The segmentation system pre-processs 806 a second set of the images using the threshold image to obtain pre-processed images. The second set of the images may be images that were captured after the first set of the images were captured. To pre-process the images, the segmentation system may compare each image of the second set of the images to the threshold image. The comparison may be a pixel by pixel comparison. If the image value at a given pixel is less than the image value of the corresponding pixel of the threshold image, the segmentation system may set the image value to a particular value indicating the threshold value was not met (e.g., set the image value such that the modified image value represents the color black or the absence of fluorescence). If the image value at a given pixel meets or exceeds the image value of the corresponding pixel of the threshold image, the segmentation system may keep the image value unchanged.

The segmentation system determines 808 a first number of target entities in a first image of the pre-processed images. The segmentation system may apply a rule-based model to each pixel or region of pixels of the first image to determine whether a target entity is located at each pixel or region of pixels. The segmentation system may apply a machine learning model to the image, the machine learning model trained to classify spots in the first image where target entities are likely to be located with a minimum confidence level. Similarly, the segmentation system determines 810 a second number of target entities in a second image of the pre-processed images.

The segmentation system determines 812 whether the first and second numbers of target entities in the sample provide an estimated number of target entities in the sample with at least a threshold certainty. The segmentation system may determine that the number of target entities is stable (e.g., the difference between the first and second numbers is not greater than a threshold difference) or that the confidence score (e.g., as determined by a machine learning model) for the first and second numbers is at least a threshold confidence score.

If the threshold certainty is not met, the segmentation system determines 814 a third number of target entities in a third image of the pre-processed images. In some embodiments, determining the third number of target entities is based on preceding images in the second set of images, where the preceding images include the first and second images. The first and second images may be successive images of the sample. The segmentation system may apply the first and second images to a machine learning model trained to identify spots in a series of images according to a binding signature depicted across the series of images. The number of identified spots may be the third number of target entities.

If the threshold certainty is met, the segmentation system generates 816 a user interface output using the second number of target entities in the sample. For example, the user interface may display the estimated number of target entities as the second number. In another example, the user interface displays the estimated number of target entities as an average of the first and second numbers. The user interface may depict the binding signatures of the target entities identified. The user interface may depict a color coded version of the images, where each pixel of the images may be encoded with a color according to a particular test of a rule-based model applied to determine whether a target entity was located at the pixel.

### Computing Machine Architecture

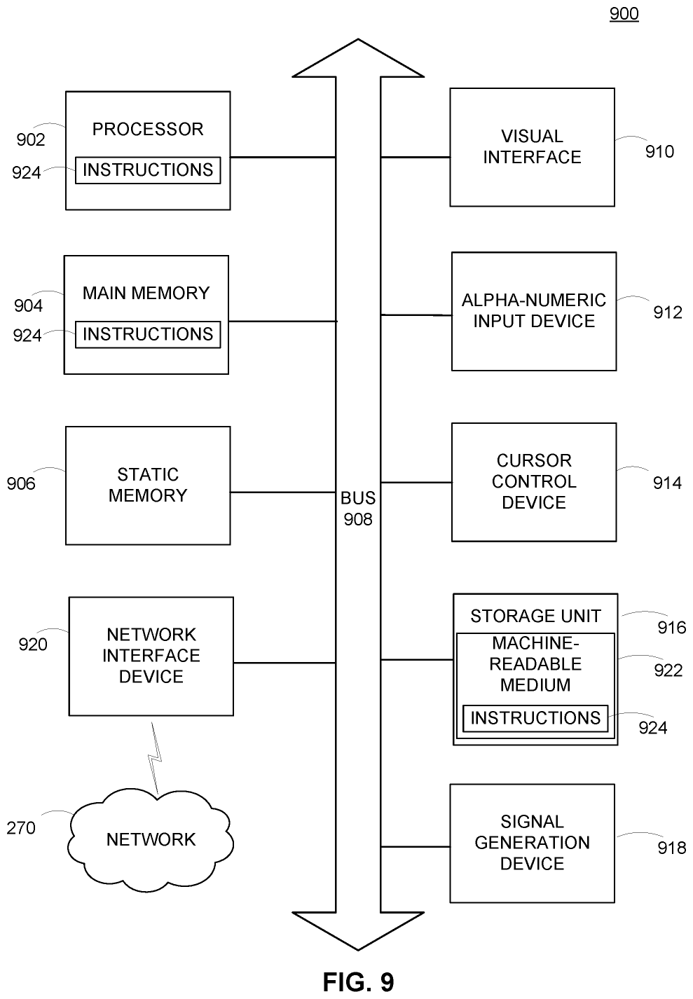

FIG. 9 is a block diagram illustrating components of an example machine able to read instructions from a machine-readable medium and execute them in a processor (or controller). Specifically, FIG. 9 shows a diagrammatic representation of a machine in the example form a computer system 900, within which program code (e.g., software or software modules) for causing the machine to perform any one or more of the methodologies discussed herein may be executed. The program code may be comprised of instructions 924 executable by one or more processors 902. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment or connected to a wide area network (WAN) allowing the system's alerts to be sent via email and text messages.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes a processor 902 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 904, and a static memory 906, which are configured to communicate with each other via a bus 908. The computer system 900 may further include visual display interface 910. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 910 may include or may interface with a touch enabled screen. The computer system 900 may also include alphanumeric input device 912 (e.g., a keyboard or touch screen keyboard), a cursor control device 914 (e.g., a mouse, a trackball, a joystick, a motion sensor, or other pointing instrument), a storage unit 916, a signal generation device 918 (e.g., a speaker), and a network interface device 920, which also are configured to communicate via the bus 908.

The storage unit 916 includes a machine-readable medium 922 on which is stored instructions 924 (e.g., software) embodying any one or more of the methodologies or functions described herein. The instructions 924 (e.g., software) may also reside, completely or at least partially, within the main memory 904 or within the processor 902 (e.g., within a processor's cache memory) during execution thereof by the computer system 900, the main memory 904 and the processor 902 also constituting machine-readable media. The instructions 924 (e.g., software) may be transmitted or received over a network 670 via the network interface device 920.

While machine-readable medium 922 is shown in an example embodiment to be a single medium, the term “machine-readable medium” should be taken to include a single medium or multiple media (e.g., a centralized or distributed database, or associated caches and servers) able to store instructions (e.g., instructions 924). The term “machine-readable medium” shall also be taken to include any medium that is capable of storing instructions (e.g., instructions 924) for execution by the machine and that cause the machine to perform any one or more of the methodologies disclosed herein. The term “machine-readable medium” includes, but not be limited to, data repositories in the form of solid-state memories, optical media, and magnetic media.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Where values are described as “approximate” or “substantially” (or their derivatives), such values should be construed as accurate +/−10% unless another meaning is apparent from the context. From example, “approximately ten” should be understood to mean “in a range from nine to eleven.”

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A non-transitory computer readable medium comprising instructions, the instructions, when executed by a computer system, causing the computer system to perform operations including:
obtaining images, captured by an image sensor, of a sample including fluorescent entities, the fluorescent entities comprising target entities bound to fluorophore;
determining a threshold image using a first set of the images, the threshold image representing background illumination differing from fluorescence of the target entities;
pre-processing a second set of the images using the threshold image to obtain pre-processed images;
determining a first number of target entities in a first image of the pre-processed images;
determining a second number of target entities in a second image of the pre-processed images;
in response to the first number and the second number providing a first estimate of the number of target entities in the sample with less than a threshold certainty, determining a third number of target entities in a third image of the pre-processed images; and
in response to determining that the third number provides a second estimate of the number of target entities in the sample with at least the threshold certainty, generating a user interface output using the second estimate of the number of target entities in the sample.

2. The non-transitory computer readable medium of claim 1, wherein the operations further include, in response to determining that the third number provides a second estimate of the number of target entities in the sample with at least the threshold certainty:
for each target entity of the second estimate of the number of target entities:
for each of the pre-processed images, determining an image value of the image location, the image value representative of a corresponding fluorescence of the target entity; and
determine a binding signature of the target entity using the corresponding fluorescence of the target entity in each of the pre-processed images.

3. The non-transitory computer readable medium of claim 2, wherein the operations further include, in response to determining that the third number provides a second estimate of the number of target entities in the sample with at least the threshold certainty:
for each target entity of the second estimate of the number of target entities:
generating a signature feature vector using the binding signature and a concentration of a solution of the sample; and
applying a signature fitting model to the signature feature vector, the signature fitting model trained to determine a binary pattern that fits the binding signature.

4. The non-transitory computer readable medium of claim 3, wherein the binary pattern is one of a plurality of predetermined binary patterns, each of the predetermined binary patterns corresponding to a known target entity.

5. The non-transitory computer readable medium of claim 1, wherein the operations further include, in response to determining that the third number provides a second estimate of the number of target entities in the sample with at least the threshold certainty:
filter one or more of the second estimate of the number of target entities by:
determining a set of the image locations of the estimated number of target entities for which corresponding image values exceed a fluorescing threshold for over a threshold number of consecutive images of the pre-processed images;
identifying exclusion zones bounding the respective image locations; and
filtering the one or more of the second estimate of the number of target entities having corresponding image locations within the exclusion zones.

6. The non-transitory computer readable medium of claim 1, wherein the operations further include, in response to determining that the third number provides a second estimate of the number of target entities in the sample with at least the threshold certainty:
filter one of the second estimate of the number of target entities by:
determining a set of image locations of a pair of the second estimate of the number of target entities, the distance between the image locations of the pair less than or equal to a threshold distance; and
filtering the one of the second estimate of the number of target entities having one of the image locations of the pair.

7. The non-transitory computer readable medium of claim 1, wherein the first number of target entities in the first image of the pre-processed images is determined in substantially real time as the images are captured by the image sensor.

8. The non-transitory computer readable medium of claim 1, wherein determining the first number of target entities in the first image of the pre-processed images comprises:
applying a rules-based model to the pre-processed images, at least one rule of the rules-based model specifying a fluorescing threshold for which image values above the fluorescing threshold indicate a target protein.

9. The non-transitory computer readable medium of claim 1, wherein determining the first number of target entities in the first image of the pre-processed images comprises:
applying a machine learning model to the pre-processed images, the machine learning model trained to classify target entities in an image of a given sample based on historical images of samples.

10. The non-transitory computer readable medium of claim 9, wherein the operations further comprise:
generating a training set using the historical images of samples labeled to indicate a presence or an absence of target entities; and
training the machine learning model using the training set.

11. The non-transitory computer readable medium of claim 1, wherein determining the threshold image using a first set of the images comprises:
for each of the first set of the images:
partitioning the image into a plurality of sub-images;
determining a plurality of histograms of intensities for the plurality of sub-images;
for each of the plurality of histograms:
identifying a peak in a histogram of a sub-image, wherein the peak has a height and a width, and wherein an intensity at the peak represents a background intensity within the sub-image; and
determining a standard deviation of intensities within the peak in the histogram, wherein the standard deviation represents a background noise within the sub-image;
determining a background image using a plurality of background intensities of the plurality of sub-images;
determining a standard deviation image using a plurality of background noises of the plurality of sub-images; and
determining the threshold image using the background image and the standard deviation image.

12. The non-transitory computer readable medium of claim 1, wherein the operations further include:
accessing a plurality of color codes indicating which of one or more criteria a given image value has met for determining whether a target entity is present at an image location corresponding to the given image value;
generating a color-coded version of an image of the pre-processed images using the plurality of color codes;
displaying a GUI including the color-coded version of the image.

13. The non-transitory computer readable medium of claim 1, wherein the fluorescent entities include fluorophores bound to a matrix component and fluorophores bound directly to biotin on a surface of a coverslip.

14. The non-transitory computer readable medium of claim 1, wherein the target entity includes an antigen.

15. The non-transitory computer readable medium of claim 1, wherein determining the third number of target entities in the third image of the pre-processed images is based on preceding images in the second set of images, the preceding images including the first image and the second image.

16. A method comprising:
obtaining images, captured by an image sensor, of a sample including fluorescent entities, the fluorescent entities comprising target entities bound to fluorophore;
determining a threshold image using a first set of the images, the threshold image representing background illumination differing from fluorescence of the target entities;
pre-processing a second set of the images using the threshold image to obtain pre-processed images;
determining a first number of target entities in a first image of the pre-processed images;
determining a second number of target entities in a second image of the pre-processed images;
in response to the first number and the second number providing a first estimate of the number of target entities in the sample with less than a threshold certainty, determining a third number of target entities in a third image of the pre-processed images; and
in response to determining that the third number provides a second estimate of the number of target entities in the sample with at least the threshold certainty, generating a user interface output using the second estimate of the number of target entities in the sample.

17. The method of claim 16, further comprising, in response to determining that the third number provides a second estimate of the number of target entities in the sample with at least the threshold certainty:
for each target entity of the second estimate of the number of target entities:
for each of the pre-processed images, determining an image value of the image location, the image value representative of a corresponding fluorescence of the target entity; and
determine a binding signature of the target entity using the corresponding fluorescence of the target entity in each of the pre-processed images.

18. The method of claim 17, further comprising, in response to determining that the third number provides a second estimate of the number of target entities in the sample with at least the threshold certainty:
for each target entity of the second estimate of the number of target entities:
generate a signature feature vector using the binding signature and a concentration of a solution of the sample; and
apply a signature fitting model to the signature feature vector, the signature fitting model trained to determine a binary pattern that fits the binding signature.

19. The method of claim 17, further comprising, in response to determining that the third number provides a second estimate of the number of target entities in the sample with at least the threshold certainty:
filter one or more of the second estimate of the number of target entities by:
determining a set of the image locations of the estimated number of target proteins for which corresponding image values exceed a fluorescing threshold for over a threshold number of consecutive images of the pre-processed images;
identifying a plurality of exclusion zones bounding the respective image locations; and
filtering the one or more of the second estimate of the number of target entities having corresponding image locations within the plurality of exclusion zones.

20. The method of claim 16, wherein the first number of target entities in the first image of the pre-processed images is determined in substantially real time as the images are captured by the image sensor.
